(19) United States
(12) Patent Application Publication
(10) Pub. No.: US 2022/0126125 A1
(43) Pub. Date: Apr. 28, 2022

(54) FACIAL AIR SHIELD TO PREVENT DISEASE SPREAD

(71) Applicant: SYNERGYMED DEVICES INC., Lewes, DE (US)

(72) Inventor: Anan COPTY, Jerusalem (IL)

(21) Appl. No.: 17/507,192

(22) Filed: Oct. 21, 2021

Related U.S. Application Data
(60) Provisional application No. 63/104,211, filed on Oct. 22, 2020.

(51) Int. Cl. A62B 18/00; A41D 13/11

(52) U.S. Cl. CPC A62B 18/003; A41D 13/1184

(57) ABSTRACT

The present disclosure provides devices and systems for prevention from air born viruses, bacteria or contaminants, in particular, the device acts as an air shield that is placed on the human forehead and generates a differential high pressure in front of the human face that blocks the viruses from reaching the face. The device is composed of air fans with controlled speeds, air filters, an air cone, an air slot, and controlled circuitry to operate the device.

### CROSS REFERENCE TO RELATED APPLICATIONS

This application claims priority to U.S. Provisional Application No. 63/104,211 filed Oct. 22, 2020. The contents of this application are incorporated by reference herein in their entirety.

### TECHNICAL FIELD

The present disclosure generally relates to the field of virus transport prevention. In particular, the present disclosure relates to a device that performs as a face mask by creating an air shield that blocks air borne viruses, bacteria and dust particles, from entering the human body system through the mouth, the nose, or contact with eyes or facial skin.

### BACKGROUND

The onset of Covid-19, also popularly known as the Corona Virus that appeared in December 2019 in China, and then the rest of the world in 2020, has prompted the widespread use of medical face masks and face shields to prevent the virus spread.

Existing face masks typically apply a filter cloth that is placed over the mouth, nose, and cheeks of the user. The filter may be tied through a ribbon that is placed around the ears.

Some of the issues with conventional masks include: (1) breathing and talking discomfort for users, especially, when the masks are worn for extended periods. (2) Viruses or air borne containments can stick on the masks which can make the masks carriers of the virus. (3) Most masks do not cover the eyes unless an additional transparent face shield is used. (4) Face masks also cause discomfort in hot weather as they can make people sweat. (5) For people wearing glasses they may fog the glasses due to exhaled air being directed upward by the mask. (6) It is not possible to see the facial expressions of people when they are covered with face masks. It also prevents reading people's lips for hearing impaired people. Crucially, (7) many masks do not provide a completely filtered environment around the mouth and the nose. This is because in many masks the fringes of the mask do not fully conform to the contours of the face, leaving unfiltered spaces between the face and the fringes of the mask, typically on the cheeks below the eyes. In addition, surgical masks do not block particles smaller than ˜0.7 μm in size.

Thus, there is a need in the art for a technical solution that allows a user to talk and breathe more comfortably, cover the eyes, nose, mouth and skin, is comfortable in warm weather and does not fog eye glasses and provides more effective protection.

### SUMMARY

According to some embodiments, there is provided an advantageous device which creates an air shield or air curtain around the face, and thereby prevents the drift of air borne containments towards the face, without causing breathing or talking discomfort to the user. In some embodiments, the device creates a faceless mask which prevent airborne viruses, bacteria or containments from reaching the face. In some embodiments, the device reduces the forward travel of exhaled air particles generated by a person wearing the device as the air shield generated by the device would slow down the trajectory of the outgoing particles. This last point illustrates a further potential advantage of the device, whereby the device not only protects the user, but also potentially offers protection to other people (even ones not using the device), for example, a person facing the user (e.g. a person with whom the user is having a face-to-face conversation).

According to some embodiments, there is provided a device which may be positioned on the human forehead. According to some embodiments, the device generates air through a fan or a collection of fans. Additionally, or alternatively, according to some embodiments, the device may generate the air shield through an air compressor. The air may be focused through a funnel and exits the funnel through an air inlet, which may be in the form of a thin air slot. The air forced out of the slot forms an (air) shield that extends from the slot to the bottom of a user's (i.e. the person wearing the device) face. According to some embodiments, the high air pressure generated by the air shield prevents air borne viruses or contaminants from reaching the face of a subject wearing the device. According to some embodiments, the device includes one or more air filters placed at the top or side of the device to clean the air drawn into the device.

According to some embodiments, there is provided a device, which advantageously may obviate the need to use conventional devices which are uncomfortable for talking or breathing, may fog glasses, allow viruses to attach to them, hide facial expressions, and do not protect the eyes, and/or which may sometimes offer only partial protection, as described in the Background. According to some embodiment, the device may be supplemented with an optically transparent, plastic or polymer based, face shield that may be attached to the device. According to some embodiments, the device may be used in addition to standard mask (e.g. a surgical mask), thereby potentially offering even greater protection, and as a further advantage substantially reducing the likeliness of viruses to attach to the mask.

According to some embodiments, the devices disclosed herein are configured to form a high-pressure region in front the face, which is created by fast (and filtered) air forced out of a slot from the device. According to some embodiments, suitable air speeds are chosen to block coughs, sneezes, or airborne containments that are present in the room. In particular, the speed of the air forced out of the device—and consequently the pressure in the region in front the face—may be selected such that if a person coughs and/or sneezes next to a subject wearing the device, respiratory droplets from the person would not reach the face of the user. According to some embodiments, the air speed exiting the air slot is higher than ambient wind speed or airflow speed generating a differential pressure region that prevents airborne viruses or containments from arriving at the face. According to some embodiments, the speed of the air exiting the air slot is higher than the airflow speed of sneezes or coughs generated by people, so that a high differential pressure region is formed in front of the face, which prevents viruses from people sneezing or coughing from arriving at the face. According to some embodiments, the kinetic energy of air in the air shield region is higher than the kinetic energy of the incoming particles from a cough or sneeze by a nearby person. Typical speeds of air expelled by a person by sneezing or coughing at the person's mouth are in the range from 0.5 m/s to 30 m/s with a median speed of ˜4 m/s. These air speeds of sneezing or coughing may be reduced exponentially as a function of the distance from the face (of the sneezing and/or coughing person). Typically, already at a distance of 30 cm from the sneezing and/or coughing person's mouth, the air speeds are less than 1 m/s.

According to some embodiments, the air slot may be inferiorly directed, that is, at an angle pointing down along the face. According to some embodiments, the air slot may be at an angle pointing out of the face (e.g. so that the air slot is directed both inferiorly and anteriorly). According to some embodiments, the air slot may be at about 1 degree to about 30 degrees pointing out of the face (where it is to be understood that at 0 degrees the air slot is fully inferiorly directed). According to some embodiments, the width of the air slot is in the range of about 0.5 to about 5 mm. According to some embodiments, the width of the air slot is in the range of about 6 to about 10 mm. According to some embodiments, the width of the air slot is in the range of about 10 to about 30 mm. According to some embodiments, the width of the air slot may be about equal to the width of the forehead.

According to some embodiments, the speed of the air fans in device may be controlled manually by the user (i.e. the person wearing the device). According to some embodiments, the speed of the fans may depend on the presence of other people in the surrounding and is triggered by a motion sensor. According to some embodiments, the speed of the fans, and thereby, the generated air pressure in front of the face will be higher than normal in the presence of other people who are about 2 meters or closer to the user. According to some embodiments, the speed of the fans, and thereby, the generated air pressure in front of the face will be higher than normal when known containments are known to be present in the ambient region.

According to some embodiments, the air speed coming out of the slot is the range of about 2 m/s to about 10 m/s. In some embodiments, the air speed is the range of about 10 m/s to about 20 m/s. In some embodiments, the air speed may be higher than about 20 m/s, about 30 m/s, or even about 50 m/s. According to some embodiments, the air pressure generated by air shield depends on the wind (or airflow) speed square according to P=1/2dv2 where P is the air pressure in Pascal, d is air density, which may be around 1.292 Kg/m3 and v is the wind (or airflow) velocity. According to some embodiments, and by way of a non-limiting example, an air speed of 10 m/s generated by the device, compared to a typical open room wind speed of 1 m/s (e.g. when windows are open) or a closed room airflow speed of 1 m/s (e.g. due to an air conditioning system or a ceiling fan), would give rise to a differential pressure of ΔP=60.5 Pascal.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1 A schematic illustration of an air shield device, according to some embodiments;

FIG. 2—A schematic illustration of an air shield device which further includes a solid transparent face shield, according to some embodiments;

FIG. 3—A schematic close-up view illustration of an air shield device system in a top-down view, according to some embodiments;

FIG. 4—A schematic illustration of an air shield device with a tilted air slot, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

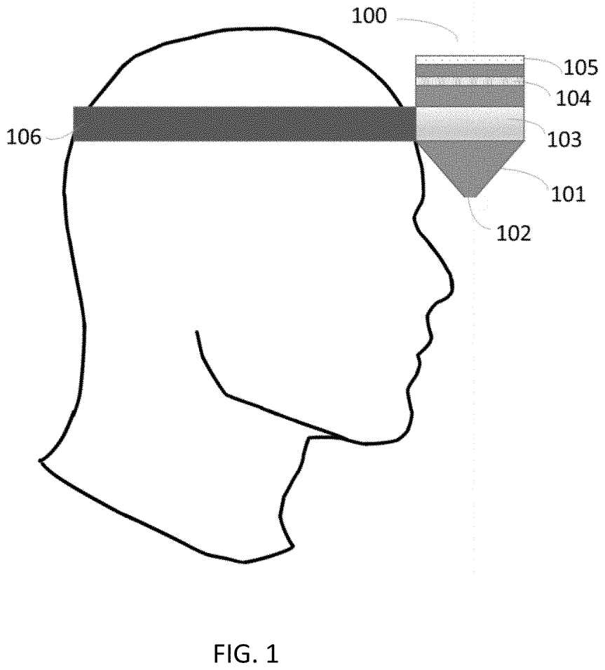

Reference is now made to FIG. 1, which schematically illustrates a device 100 configured to create an air shield. As shown in FIG. 1, device 100 includes a cone-like structure 101 which forces air out of an air inlet, here in the form of an air slot 102. The air exiting air slot 102 creates a differential air pressure system, which acts as a (pressure) shield in front of the face of a user (i.e., a person who has device 100 placed on his forehead as depicted in FIG. 1). Above the cone-like structure 101 there is positioned a second structure 103, which forms a fan compartment. Second structure 103 contains (i.e. has housed therein) one or more air fans, which are configured to force air into cone-like structure 102 (the air then exits via air slot 102). External air enters into device 100 through one or more filters. Device 100 includes a high-resolution filter 104, which may be positioned or mounted above second structure 103. Filter 104 is configured to prevent small viruses from entering device 100. According to some embodiments, device 100 may further include a low-resolution filter 105. Filter 105 may be configured to prevent large dust particles from entering into device 100. Low resolution filter 105 may be positioned above high-resolution filter 104. According to some embodiments, Device 100 may be held to the forehead through a head strap 106 or head band. According to some embodiments, device 100 may be mounted on a capless hat. According to some embodiments, device 100 may include batteries to power the fans, which may be rechargeable and/or replaceable. According to some embodiments, device 100 may be configured to be connected to an external power source (e.g. an external battery pack) via a power cable (e.g. a mini USB power cable). Device 100 may further include control circuitry (not shown) configured to allow operating and controlling functions of device 100. In particular, the control circuitry may be configured to switch on and off the fans, and optionally, the speed of rotation of the fans, and thereby the speed of the air forced out of air slot 102 and the magnitude of the pressure differential generated thereby. According to some embodiments, device 100 may be controlled using an external controller, which may be functionally associated with the control circuitry either wirelessly (e.g. via Bluetooth) and/or by wire. According to some embodiments, the external controller may be a mobile computational device, such as a smartphone or smartwatch of the user. The mobile computational device may have installed thereon an app configured to control the functions of device 100. The control circuitry may further be configured to regulate the speed of the fans such as to save battery life. According to some embodiments, the mobile computational device may be configured to sense presence and proximity of other people using based on analysis of sound registered by the microphone of the mobile computational device. In particular, the app may be configured to analyze the registered sounds in real-time or near real-time. Using machine learning tools, the app may be trained to recognize, for example, the sound of speech or footsteps and from the strength of the registered signal and its purity (since the farther away a walking person is, or a group of talking people are, the more likely that the signal associated with their footsteps or speech will be weaker or diluted by other sounds, e.g. birds or cars). The app may be farther configured to recognize the voice of the user and not take it into account in determining the presence and proximity of other people.

While in FIG. 1, device 100 is depicted as including a conical lower section, it will be understood that other shapes are possible and fall within the scope of the disclosure. According to some embodiments, device 100 may rectangular or cylindrical. According to some embodiments, a lateral cross-section of device 100 grows narrower in the inferior direction being thereby configured to force out a jet of air at an increased speed. According to some embodiments, an anterior surface of device 100 may be curved such as to conform to the shape of the forehead of a user. Similarly, according to some alternative embodiments, the air outlet through which air is forced out of device 100 is not in the shape of a slot and may, for example, be round or rectangular.

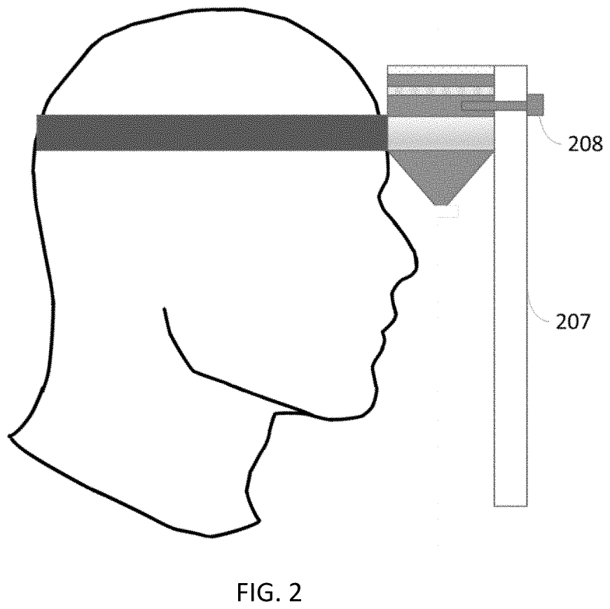

Reference is now made to FIG. 2 which shows an additional element that can be connected to the air shield (i.e. device 100), according to some embodiments. As shown in FIG. 2, according to some embodiments, device 100 may be connected to, or have mounted thereon, a transparent face shield 207 made of plastic or polymer to further block viruses or containments in high risk environments such as operation rooms or shelters for infected people. According to some embodiments, shield 207 may be attached to device 100 through a pin 208, or a few pins, or one or more screws, to hold it firmly in place. According to some embodiments, shield 207 may be detachably mountable on device 100, so that device 100 may be used with or without shield 207.

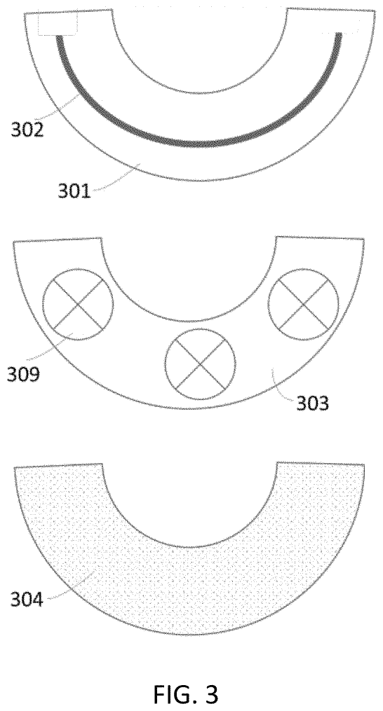

Reference is now made to FIG. 3 which shows a schematic close-up view illustration of components of an air shield device, which is a specific embodiment of device 100. Three cross-sectional views of three components of device 100 are shown. The first cross-sectional view is of a cone-like structure 301, which is a specific embodiment of cone-like structure 101. The cross-section is taken along a bottom surface of cone-like or a flat structure 301. Also shown is a slot 302 on bottom surface 301. Slot 302 is a specific embodiment of slot 102. Slot 302 is configured to create a narrow wall of high-pressure air in front of the human face. Also shown is a lateral cross-sectional view of a second structure 303, which is a specific embodiment of second structure 103. Second structure may include (have housed therein) a single fan or an array of fans 309 (for example, three as depicted in FIG. 3), which are configured to draw air into the air-shield device and generate a strong air flow out of the device through air slot 302. Also shown is a lateral cross-sectional view of an air filter 304, which according to some embodiments is a specific embodiment of high-resolution filter 104. Air filter 304 is configured to block contaminants from entering into the air-shield device.

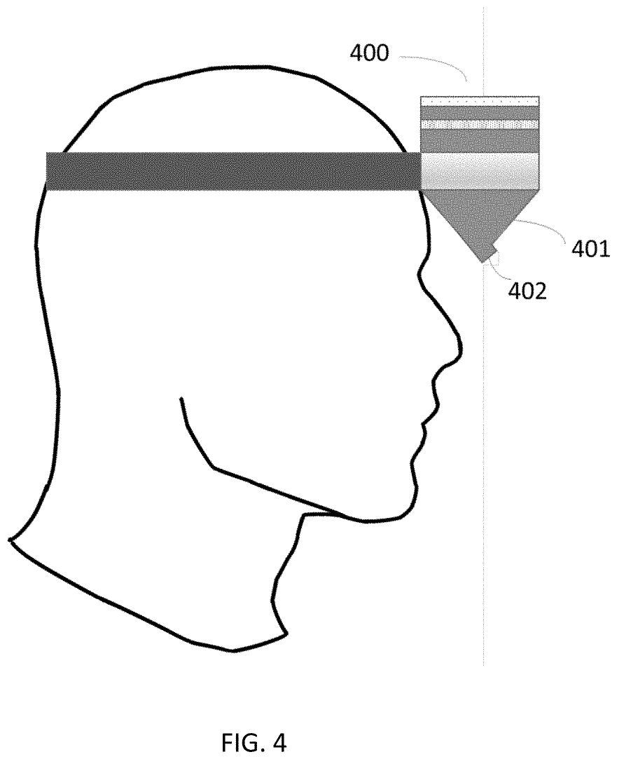

Reference is now made to FIG. 4, which schematically illustrates an air shield device 400, according to some embodiments. Air shield device 400 is similar to air shield device 100 but may differ therefrom in that in an air slot 402 of device 400 being tilted. According to some embodiments, air slot 402 is tilted (i.e. oriented) at an angle of 1 to 30 degrees, such that the air exiting the slit creates an air shield pointing away from the face of the user wearing device 400. This configuration may be preferable to some users since the air coming out of the device blows away from the face.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 99% and 101% of the given value. In such embodiments, for example, the statement “the length of the element is equal to about 1 millimeter” is equivalent to the statement “the length of the element is between 0.99 millimeters and 1.01 millimeters”. According to some embodiments, “about” may specify the value of a parameter to be between 95% and 105% of a given value. According to some embodiments, “about” may specify the value of a parameter to be between 90% and 110% of a given value. According to some embodiments, “about” may specify the value of a parameter to be between 80% and 120% of a given value.

As used herein, according to some embodiments, the terms “substantially” and “about” may be interchangeable.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1. A facial air-shield device, the device comprising a device body configured to be positioned on a forehead of a user, the device body comprising an air inlet, an air outlet, at least one filter, and at least one air fan;
wherein the at least one air fan is configured to draw in air through the air inlet and force out high pressure air through the air outlet, thereby generating a high pressure air shield which acts to prevent airborne viruses and containments from reaching the face of a user;
wherein the at least one air filter is configured to filter air drawn into the device body through the air inlet, such that air forced out of the device body through the air outlet is clean.

2. The device of claim 1, wherein the device body narrows in the inferior direction.

3. The device of claim 1, wherein the device body is conical or includes a conical bottom section.

4. The device of claim 1, wherein the air outlet is positioned at the bottom section of the device and points at least in part inferiorly from the forehead when the device is properly worn.

5. The device of claim 1, wherein the air outlet is in the form of a slot.

6. The device of claim 1, further comprising control circuitry configured to regulate, or allow a user to set, a rotation speed of the fan(s) and thereby control the pressure of the air-shield.

7. The device of claim 6, wherein the control circuitry is configured to switch on the fan(s), or increase a rotation speed of the fan(s), on receipt of a signal indicative of the user being in a risky environment, and, optionally, wherein the control circuitry is configured to switch off the fan(s) or decrease the rotation speed of the fan(s), on receipt of a signal indicative of the user having exited a risky environment.

8. The device of claim 6, configured to be used in conjunction with a mobile computational device having stored thereon an app functionally associated with the control circuitry and configured to command the control circuitry.

9. The device of claim 8, wherein the signal indicative of the user being in a risky environment is received from the mobile computational device.

10. The device of claim 6, further comprising a sensor configured to obtain environmental information, wherein the control circuitry is configured to process the environmental information, and accordingly adjust one or more operational parameters of the fan(s) to maximize protection of the user.

11. The device of claim 1, further comprising one or more batteries configured to power the device.

12. The device of claim 11, wherein the batteries are rechargeable and/or replaceable.

13. The device according to claim 1, wherein the at least one speed adjustable fan is utilized.

14. The device of claim 1, wherein the device comprises an array of speed adjustable air fans.

15. The device of claim 1, wherein the fan(s) are positioned in a fan compartment and wherein the at least one filter is positioned above the fan compartment, the at least one filter being thereby configured to prevent contaminated air or viruses from entering the fan compartment and exiting through the air outlet.

16. The device according to claim 1, wherein the device contains a high-resolution air filter to prevent contaminated air or viruses from entering the fan compartment or at least from exiting through the air outlet.

17. The device according to claim 1, wherein the device contains a low-resolution air filter to prevent large dust particles from entering into the fan compartment or at least from exiting through the air outlet.

18. The device of claim 17, wherein the low-resolution air filter is positioned above the high-resolution air filter, being thereby configured to prevent blockage of the high resolution air filter.

19. The device according to claim 10, wherein the sensor is or includes a motion sensor, which is used to indicate the presence of other people in the vicinity of the user.

20. (canceled)

21. (canceled)

22. (canceled)

23. (canceled)

24. (canceled)

25. (canceled)

26. A system to prevent from air borne viruses or contaminants from reaching the face of a user, the device comprising the device of any one of claim 1 and at least one transparent solid air shield, which is configured to be placed is placed on the device.

27. (canceled)

28. (canceled)

29. (canceled)
